(19) United States
(12) Patent Application Publication
(10) Pub. No.: US 2009/0120201 A1
(43) Pub. Date: May 14, 2009

(54) Ball Compression Testing Apparatus

(76) Inventor: Conrad Mendoza, Camas, WA (US)

Correspondence Address: CONRAD S. MENDOZA, P.O. BOX 1158, CAMAS, WA, 98607, US

(21) Appl. No.: 11/940,127

(22) Filed: Nov. 14, 2007

(51) Int. Cl. G01N 3/08

(52) U.S. Cl. 73/818

(57) ABSTRACT

A golf ball compression testing apparatus has a main body with a ball receiving chamber and pistons movably mounted in aligned bores in the body and extending into the chamber to engage opposite portions of the ball. The first piston is spring loaded into an advanced position engaging the ball, while the second piston is spring loaded away from the ball and urged by a handle operated actuator into an extended position engaging the ball. A pressure gauge associated with the first piston measures a compression rating of the ball when the second piston is moved into the advanced position. Rotation of the handle away from a test position retracts the actuator and allows the second piston to move away from the ball. In one embodiment, a clutch assembly associated with the actuator resists the tendency of the handle to snap back into the inoperative position under the action of the piston return spring.

### BACKGROUND

1. Field of the Invention

This invention relates generally to an apparatus for testing the hardness or compressibility of a ball, and is particularly concerned with a hand held apparatus for golf ball compression testing.

2. Related Art

Golf balls vary in hardness or compressibility, and golfers can select balls of desired hardness or compression rating based on their skill level and playing conditions. For example, in cold weather conditions a softer ball may be preferable, while a golfer may wish to play with a harder ball in hot weather. Softer balls are generally preferred by players with less physical strength. Various test devices have been used in the past to measure the compression rating of a golf ball, including larger scale machines such as that described in U.S. Pat. No. 4,555,028 of Valehrach, and smaller, hand held devices that can be used by the individual golfer, for example the hand held golf ball compression and sphericity tester described in U.S. Pat. No. 6,196,073 of Harding. In Harding, a golf ball is inserted into the testing apparatus into a position between two opposing plates, one of which is attached to a calibrated spring and the other of which is attached to a screw used to drive the attached plate against the ball. This applies a predetermined force to the ball, and the amount of compression can be read on a scale on the apparatus.

Another hand held golf ball compression and sphericity tester is manufactured by Majestix Golf of Temecula, Calif. (see www.majestixgolf.com). This also involves compressing a ball between two plates or pistons, but in this case the movable plate is actuated by a rotatable drive shaft which has cam or roller bearings which act against a face of the plate or piston to drive it into an extended position against the action of a return spring. A handle is secured to the drive shaft and is actuated by the user to rotate the shaft between an operative position in which the plate is extended and an inoperative position in which the plate or piston is returned by a spring into the retracted position.

### SUMMARY

In one embodiment, a golf ball compression testing apparatus is provided, which comprises a main body with a ball receiving cavity and first and second pistons movably mounted in aligned bores in the body and extending into the cavity to engage opposite portions of the ball. The first piston is spring loaded into an advanced position engaging the ball, while the second piston is spring loaded away from the ball and urged by a handle operated actuator or drive shaft into an extended position engaging the ball. A sensor or gauge associated with the first piston measures a compression rating of the ball when the second piston is moved into the advanced position. Rotation of the handle away from a test position retracts the actuator and allows the second piston to move away from the ball. In one embodiment, a clutch associated with the actuator or drive shaft resists the tendency of the handle to snap back into the inoperative position under the action of the piston return spring.

The actuator comprises a drive shaft extending transverse to the second piston and linked to a handle which rotates the shaft between an operative position driving the second piston into the advanced position and an inoperative position allowing the second piston to move into the retracted position. In one embodiment, a resilient grommet or ring surrounds the clutch associated with the drive shaft to resist rotation of the clutch and drive shaft. The clutch assembly thus resists the tendency of the handle to snap back into the inoperative position under the action of the spring as the operator starts to rotate the handle back towards the release position. This reduces the risk of injury as a result of the handle snapping back under the action of the ball return spring. The clutch may be a roller clutch or one-way clutch in one embodiment, and allows free turning of the drive shaft towards the test position, but resists free rotation back to a released position.

In one embodiment, the drive shaft extends transverse to a rear end face of the second piston, and at least one cam or projection on the drive shaft acts to urge the piston into the advanced position when the drive shaft is rotated into the operative position. The cam may comprise one or more bearings or rollers mounted on one side of the drive shaft. The clutch engages over an outer end of the drive shaft, and the resilient plastic ring or grommet engages over the clutch to resist rotation. A set screw or other adjustment device may be provided to vary the compression of the grommet.

The pressure gauge or indicator in one embodiment is associated with a rotatable ring carrying a scale covering golf ball compression indices from soft to hard, for example around 35 to 135, with a set point indicated at a standard golf ball compression rating of around 115 psi. The ring is rotated prior to testing a ball until the indicator or pointer associated with the gauge plunger or sensor pin points to the set point. A ball is then inserted into the ball chamber between the pistons, with the second piston in the retracted position. The handle is turned to advance the second piston and apply force to the ball, and the pointer then moves to the left or right of the set point, depending on whether the ball is harder or softer than the standard. In one embodiment, a color scale may be included on the scale ring, either in addition to or instead of the numeric scale, to provide a visual indication of ball hardness or softness. This scale may have different colors corresponding to firm, moderate, soft, and extra soft compression ratings so the ball quality may be read quickly and easily by a golfer.

### BRIEF DESCRIPTION OF THE DRAWINGS

The details of the present invention, both as to its structure and operation, may be gleaned in part by study of the accompanying drawings, in which like reference numerals refer to like parts, and in which:

FIG. 1 is a front perspective view of one embodiment a golf ball compression testing apparatus, illustrating the apparatus in a start position prior to testing a ball compression index;

FIG. 2 is a view similar to FIG. 1 but showing the apparatus in the test position in which the ball compression index is measured;

FIG. 3 is an exploded perspective view illustrating the separated components of the ball compression testing apparatus of FIGS. 1 and 2;

FIG. 4 is a cross sectional view on the lines 4-4 of FIG. 1;

FIG. 5 is an enlarged top plan view of the compression gauge or dial face of the apparatus of FIGS. 1 to 4, illustrating the numeric and color scale; and

FIG. 6 is a side elevation view of the apparatus in the test or operative position of FIG. 2, but with the outer body transparent to reveal the inner components.

### DETAILED DESCRIPTION

Certain embodiments as disclosed herein provide for a ball compression or hardness testing apparatus.

After reading this description it will become apparent to one skilled in the art how to implement the invention in various alternative embodiments and alternative applications. However, although various embodiments of the present invention will be described herein, it is understood that these embodiments are presented by way of example only, and not limitation.

Although the apparatus in the following description is designed for testing golf balls, it should be understood that this apparatus may alternatively be used for testing other types of balls as used in various sports, or other spherical objects, with appropriate adjustment of the testing chamber dimensions and the gauge or sensor set point.

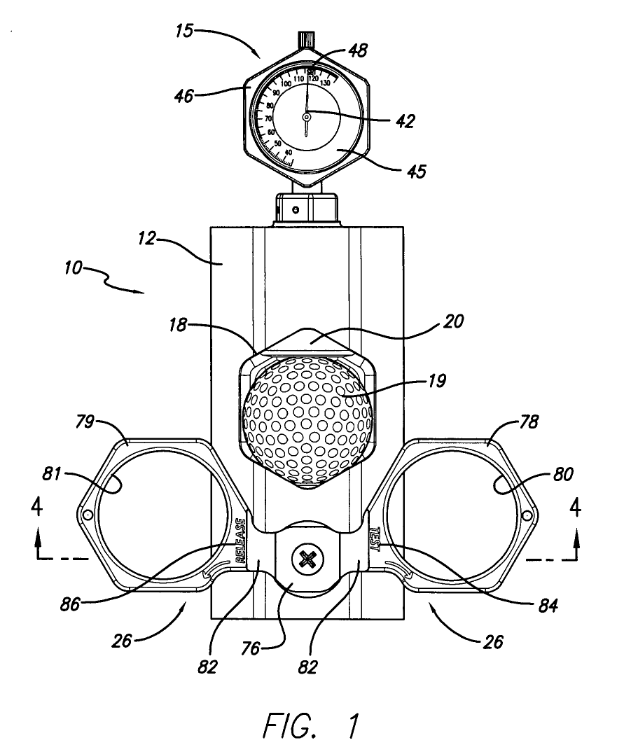

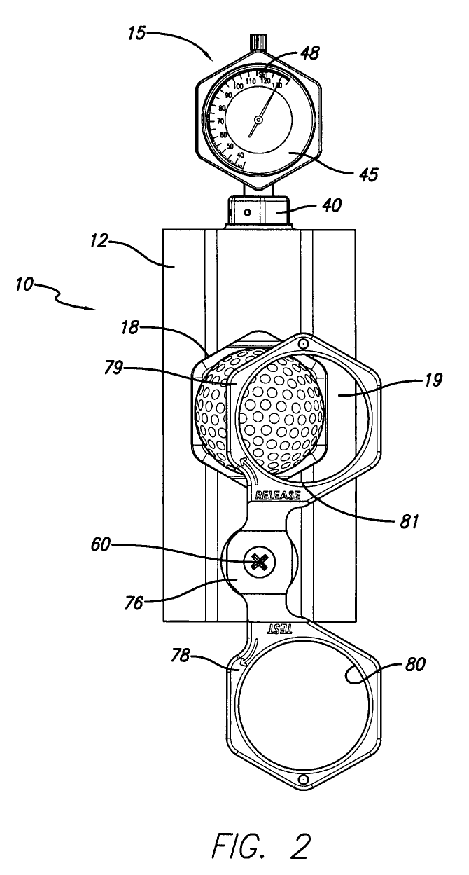

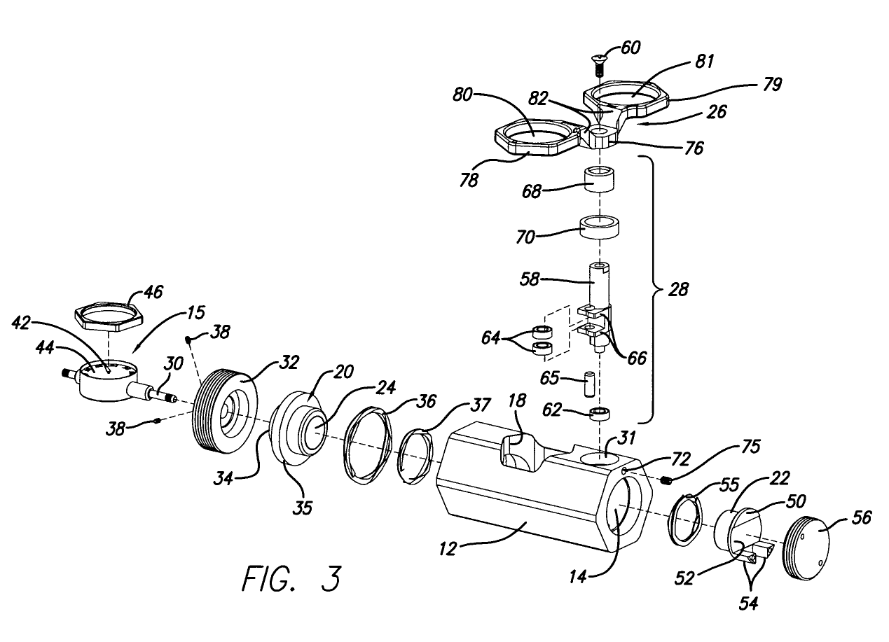

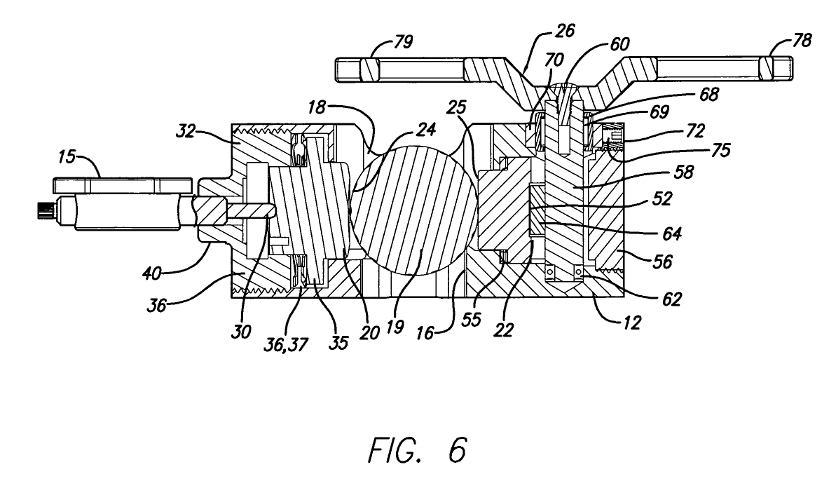

FIGS. 1 to 6 illustrate one embodiment of a golf ball testing apparatus 10 which has a main body or housing 12 with a longitudinal through bore 14 in which the internal components of the testing apparatus are mounted, as described in more detail below. The outer surface of body 12 is of hexagonal shape, but may be of other shapes in alternative embodiments, such as cylindrical or other polygonal shapes. A gauge or deflection sensor 15 is mounted at a first end of the housing. A ball testing chamber in the through bore communicates with a transverse entry opening 18 in the side of the housing for inserting a ball 19 into a ball receiving seat 16 in the chamber, as best illustrated in FIGS. 1 and 6. As best seen in FIGS. 3 and 6, first and second pistons 20,22 are mounted coaxially in the bore 14 on opposite sides of the testing chamber, and the pistons have respective end faces 24,25 which bear against diametrically opposed portions of the ball 19 when in the operative position of FIGS. 2 and 6. A handle 26 mounted on the outside of the housing is rotatable between a released position as illustrated in FIG. 1 in which it extends transverse to the longitudinal axis of the housing, and a test position as illustrated in FIG. 2 rotated through approximately ninety degrees from the position of FIG. 1 and parallel to the longitudinal axis of the housing. Handle 26 is associated with an actuator or drive assembly 28 which moves the second piston 22 between a retracted position as in FIG. 1 and an advanced position as in FIGS. 2 and 6, as explained in more detail below.

As illustrated in FIG. 3, shaft or sensor pin 30 of gauge 15 extends through an opening in end cap 32 of the housing to engage the outer end 34 of piston 20. Piston 20 has an enlarged annular flange 35, and a pair of wave springs 36,37 are located between an inner face of end cap 32 and the flange 35 to urge the piston outwardly into engagement with ball 19. A pair of set screws 38 extend radially through outer end portion 40 (FIG. 5) of the end cap 32 to cradle and guide the shaft or pin 30. The gauge may be a conventional deflection sensor or gauge and the shaft 30 is associated with a rotating needle or pointer 42 on the dial face 44 of the gauge in a known manner to move in response to deflection or movement of the piston 20. The pressure gauge is modified to provide a custom annular scale 45 connected to an outer, bezeled adjustment ring 46. The dial face 44 of one embodiment, including annular scale 45, is described in more detail below in connection with FIG. 5. The adjustment ring 46 is rotated by a user prior to testing a ball until the needle 42 points to a test position 48 on scale 45, providing a standard start position of piston 20 for every test.

The second piston 22 has an enlarged flange 50 at its outer end having a recessed outer bearing or cam follower face 52, and a pair of guide posts or pins 54 extending outwardly from one side of the bearing face or channel. A wave spring 55 is located between a shoulder 56 in through bore 14 and the flange 50 so as to bias piston 22 in a direction away from the ball seat 16 into a retracted, start position. The second piston is held in the housing by end cap 56 which engages in the second end of bore 14 as illustrated in FIGS. 3 and 6. The outer ends of pins 54 engage an inner face of cap 56 in the retracted, start position (see FIG. 6).

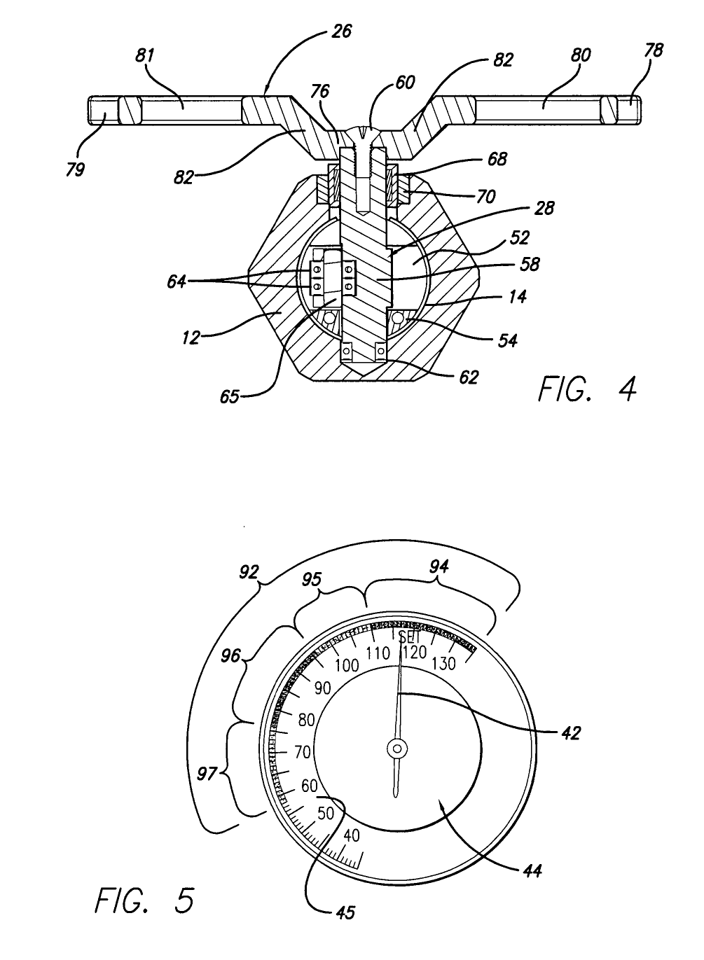

The actuator assembly 28 extends into a transverse bore 31 in housing 12 which extends transversely through the main bore 14 adjacent the outer cam follower face 52 of the second piston when in the retracted position (see FIGS. 1, 2 and 4). As best seen in FIG. 4, actuator assembly 28 includes an actuator or pivot shaft 58 having a first end connected to the handle 26 by fastener screw 60 and a second end pivotally mounted in bearing 62 at the inner end of bore 30. Rotation of the handle 26 between the start position and the test position rotates shaft 58 through approximately ninety degrees. A cam mechanism or projection is mounted on one side of the shaft and is positioned to engage the cam follower face 52 of the piston so as to move the piston into the operative position of FIGS. 2 and 5. In the illustrated embodiment, the cam mechanism comprises a pair of bearings or cam rollers 64 rotatably mounted on dowel pin 65 between mounting brackets 66 on the shaft 58. However, in alternative embodiments, any type of cam projection or device may be provided on the shaft 28, including an eccentric projection formed integrally with the shaft itself. The shaft 28 extends from the cam mechanism between the guide posts 54 of the second piston 22 and into bearing 62.

As illustrated, a clutch 68 engages over the outer end of pivot shaft 28 and is surrounded by resilient ring or grommet 70 which is seated in a recessed counter bore at the outer end of bore 30, as best illustrated in FIG. 4. In one embodiment, clutch 68 comprises a bearing or roller clutch having a plurality of inner rollers or bearings 69 engaging the drive shaft. A small threaded bore 72 extends from the end face 74 of housing 12 into the outer end of bore 30, and a set screw 75 in bore 72 can be adjusted so as to engage and compress grommet or ring 70 so that it engages and acts on the outer surface of roller clutch 68.

Handle 26 is of a shape similar to an eyeglass frame, and is of suitable rigid material such as metal or hard plastic. The handle has a central bridge portion 76 and a pair of end portions 78, 79 each having a generally hexagonal outer shape and a central circular opening 80, 81, respectively. As best illustrated in FIGS. 3, 4 and 6, the end portions 78,79 which the user grips when actuating the handle are coplanar and offset from the central bridge portion 76 by angled connector portions 82. The end portions 78,79 and the bridge portion 76 lie in parallel planes. The handle end portions 78, 79 are therefore spaced away from the body 12 of the apparatus, reducing the risk of a user's fingers becoming trapped when the handle is actuated. Fastener screw 60 extends through an opening at the center of bridge portion 76. Indicia may be engraved or printed on the upper surface of handle 26 to indicate the direction in which the handle should be rotated in order to test a ball and return to an inoperative position. For example, as illustrated in FIG. 1, an engraving or other marking 84 of the word “TEST” is provided on handle portion 78, along with an arrow 85 pointing in a clockwise direction. An engraving or other marking 86 of the word “RELEASE” is located on handle portion 79, along with an arrow 88 pointing in the opposite, anti-clockwise direction.

The circular openings 80, 81 in the handle are for ball diameter testing purposes and are of different standard golf ball diameters. For example, one opening may be of standard United States Golf Association (USGA) diameter, while the other may be of other standard golfing association size, such as the slightly smaller standard diameter set by the British Golf Association. These openings allow the golfer to test their balls for roundness and also for proper diameter.

FIG. 5 illustrates one embodiment of the pressure gauge dial 45 which incorporates both a numeric scale 90 and a color scale 92 for ease of reading by a golfer. In one embodiment, numeric scale 90 may extend from a compression rating or hardness of 35 to a compression rating of 135. Golf balls having a high compression rating of over 110 are normally considered hard while golf balls having a compression rating under 90 are normally considered soft. Generally, harder golf balls are used by stronger or more experienced golfers, since they can withstand the higher impact force generally applied by a stronger golfer. The hardness of the golf ball selected for play is also dependent on playing conditions, such as ground conditions and weather. In cold weather, a softer ball is generally selected, while a harder ball is preferable in hot conditions.

The set point 48 on the dial 45 of gauge 15 is at around 116, which represents a relatively hard golf ball. The color scale 92 has different colors for the different compression rating ranges 94, 95, 96, 97 indicated in FIG. 5. In one example, the following ranges and colors were used:

| | COMPRESSION RATING | |
|---|---|---|
| COLOR | RANGE | HARDNESS |
| RED (94) | 115-135 | FIRM |
| YELLOW (95) | 95-115 | MODERATE |
| GREEN (96) | 75-95 | SOFT |
| BLUE (97) | 55-75 | EXTRA SOFT |

The different colors listed above and used for the different compression rating ranges in the illustrated embodiment are just one possible example, and clearly other colors could be used in different combinations in alternative embodiments. All that is needed is that the golfer can easily recognize the type of ball from the color to which the pointer is directed on testing. In addition to the broad ranges based on basic colors as defined in the table above, each range may be further subdivided into ranges with different shades of the same color. For example, the firm part of the scale may be divided into subdivisions in different shades from light pink at the lower end of the range to dark red at the highest end of the range, e.g. light pink from 115 to 120, darker pink from 120 to 125, lighter red from 125 to 130, and dark red from 130 to 135. The other ranges can be similarly subdivided with different shades of the same basic color for each five unit range, with the highest end of the yellow part of the scale being orange, for example. This makes the gauge very easy to read without having to consider the precise numerical compression index. In one embodiment, the numbered scale may be eliminated completely and the color scale alone may be used to determine relative hardness level, with the set point indicated at the appropriate location.

As noted above, FIG. 1 illustrates the apparatus 10 in an inoperative, start position, with the handle extending transversely across one end portion of the body 12 spaced from the ball receiving opening 18. At this point, the second piston 22 is in a retracted position so that a ball 19 can be easily inserted through the opening 18 and seated on seat 16 between the two pistons 20 and 22. The golfer or operator then rotates adjustment ring 46 on the gauge 15 until the pointer 42 is directed towards the set position on dial 45. The handle 26 is then turned from the position illustrated in FIG. 1 to the test position illustrated in FIG. 2. This in turn rotates the pivot shaft 58 from the start position illustrated in FIG. 4, in which the roller bearings 64 extend in a direction parallel to the bearing or cam face 52 at the rear end of piston 22, to the test or operative position illustrated in FIG. 6, in which the rollers engage face 52 and push the piston towards the ball testing chamber (to the left as viewed in FIG. 6) into the extended position in which end face 25 engages and applies force to one side of golf ball 19. The resultant movement of first piston 20 on the opposite side of the golf ball against the loading of wave springs 36, 37 is indicative of the compressibility, or hardness, of the golf ball, and this movement is proportional to the deflection of needle or pointer 42 of gauge 15. The pressure or compression gauge 15 thus reads the compression rating or relative hardness of the ball 19.

Once the test is complete, the golfer or operator rotates the handle 26 back in the release direction from the position in FIG. 2 to the inoperative position of FIG. 1. At the same time, this rotates the pivot shaft and attached roller bearings back away from piston end face 52, and the piston 22 is urged back by wave spring 55 into the retracted or inoperative position. The ball can then be removed from the cavity or seat. The roller clutch 68 stops the handle from rotating or snapping back quickly under the action of spring 55, as could occur in the prior art design, and reduces the risk of the operators' fingers being trapped or injured in the process. This risk is further reduced by the overall design of the handle 26 in which the end portions 78 and 79 are raised or offset from the central attachment portion 76 and thus raised or spaced from the body 12 of the apparatus. The set screw 75 can be adjusted if necessary to apply further gripping force against the outside of roller clutch 68 and further resist sudden rotation of the handle in the release movement.

The above description of the disclosed embodiments is provided to enable any person skilled in the art to make or use the invention. Various modifications to these embodiments will be readily apparent to those skilled in the art, and the generic principles described herein can be applied to other embodiments without departing from the spirit or scope of the invention. Thus, it is to be understood that the description and drawings presented herein represent a presently preferred embodiment of the invention and are therefore representative of the subject matter which is broadly contemplated by the present invention. It is further understood that the scope of the present invention fully encompasses other embodiments that may become obvious to those skilled in the art and that the scope of the present invention is accordingly limited by nothing other than the appended claims.

1. A golf ball compression testing apparatus, comprising:
a main body having a longitudinal bore and an enlarged ball testing chamber in the bore for receiving a ball to be tested and dividing the bore into first and second portions;
a first piston movably mounted in the first portion of the bore and biased into an extended position projecting into the ball testing chamber to engage one surface portion of a ball located in the testing chamber;
a compression measurement gauge associated with the first piston which measures the compression rating of a ball loaded in the ball testing chamber;
a second piston movably mounted in the second portion of the bore and movable between an extended, test position projecting into the ball testing chamber to engage a diametrically opposite surface portion of a ball located in the chamber, and a retracted position;
a biasing mechanism which urges the second piston in a direction away from the ball testing chamber towards the retracted position;
an actuator mechanism which engages the second piston to move the second piston into the extended, test position;
a handle associated with the actuator mechanism which is manually operated to move the second piston between the retracted and extended positions;
the actuator mechanism comprising a drive shaft linked to the handle and rotatable between a released position in which the second piston is biased into the retracted position and an operative position engaging the second piston and urging the piston into the extended position; and
a clutch assembly associated with the drive shaft which resists rotation of the drive shaft from the operative position back to the released position under the action of the biasing mechanism;
whereby the deflection of the first piston on movement of the second piston into the extended position is dependent on the compressibility of a ball located between the pistons in the ball testing chamber and the compression gauge provides a visual indication of the compression rating of the ball.

2. The apparatus of claim 1, wherein the body has a transverse bore which intersects the second portion of the longitudinal bore, the drive shaft having an outer end secured to the handle and extending into the transverse bore and across the second portion of the longitudinal bore, the second piston having an end face adjacent the drive shaft, and the drive shaft having a radially projecting portion which engages the end face when the drive shaft is rotated into the operative position to move the second piston into the extended position.

3. The apparatus of claim 2, wherein the projecting portion comprises a pin mounted on one side of the drive shaft and extending parallel to the drive shaft, and at least one roller bearing rotatably mounted on the pin which engages the end face of the second piston.

4. The apparatus of claim 2, wherein the clutch assembly is mounted in the transverse bore around the drive shaft.

5. The apparatus of claim 4, wherein the clutch assembly comprises a roller clutch.

6. The apparatus of claim 5, further comprising a resilient ring mounted over the clutch and engaging the outer surface of the clutch to resist rotation.

7. The apparatus of claim 6, further comprising an adjustment device which adjustably urges the ring against the clutch.

8. The apparatus of claim 7, wherein the body has first and second end faces and a threaded bore extends from the second end face parallel to the longitudinal bore to intersect the transverse bore in the vicinity of the ring, and the adjustment device comprises a set screw threadably engaged in the transverse bore and engaging the outer surface of the ring.

9. The apparatus of claim 1, wherein the handle has a central portion secured to the actuator mechanism adjacent the main body, a first handle portion extending to one side of the central portion and a second handle portion extending to the opposite side of the central portion, the first and second handle portions being offset out of alignment with the central portion and spaced from the main body.

10. The apparatus of claim 9, wherein the first and second handle portions are coplanar and each has an outer rim and a central opening of predetermined diameter, the handle further comprising first and second angled portions securing the first and second handle portions, respectively, to the central portion.

11. The apparatus of claim 10, wherein the diameter of the central opening of the first handle portion is different from the diameter of the central opening of the second handle portion.

12. The apparatus of claim 1, wherein the compression measurement gauge has a first scale having portions of different colors representing different ball hardness levels.

13. The apparatus of claim 12, wherein the first scale has at least four different color portions corresponding to ball compression ratings indicating hard, moderate, soft and very soft balls.

14. The apparatus of claim 13, wherein each color portion is divided into at least three portions of different shades of the same color.

15. The apparatus of claim 13, wherein the compression measurement gauge has a second, numeric scale indicating ball compression ratings.

16. A golf ball compression testing apparatus, comprising:
a main housing having opposite first and second ends, a longitudinal bore extending between the ends, and a ball testing chamber in the bore, the housing having an opening communicating with the ball testing chamber for placement of a ball in the chamber;
a first piston in the bore on one side of the chamber biased into an extended position engaging one side portion of a ball in the chamber;
a second piston in the bore on the opposite side of the chamber biased away from the chamber;
an actuator which engages the second piston to move the second piston into an extended position engaging an opposite side portion of a ball in the chamber;
a gauge at the second end of the housing associated with the first piston which measures deflection of the first piston when the second piston moves into the extended position with a ball in the chamber between the first and second pistons;
a handle associated with the actuator and mounted on the housing for rotation between a release position extending transverse to the housing, and a test position aligned with the housing and extending over the opening, rotation of the handle into the test position moving the second piston into the extended position; and
the handle having a central portion connected to the actuator adjacent to the outer surface of the housing, and at least one end portion offset out of alignment with the central portion and away from the housing to leave a space between the end portion and the housing when the handle is in the test position.

17. The apparatus of claim 16, wherein the actuator comprises a drive shaft extending transversely across the bore in the housing and having a cam assembly on one side located in the bore, the second piston having a cam engaging face which faces away from the ball receiving cavity and the cam assembly engaging the cam engaging face when the drive shaft is rotated into the test position to force the second piston into the extended position.

18. The apparatus of claim 16, further comprising a clutch engaging the drive shaft which resists rotation of the drive shaft relative to the clutch in a direction away from the test position.

19. The apparatus of claim 18, further comprising a resilient grommet engaging over the clutch which resists rotation of the clutch and drive shaft away from the test position.

20. The apparatus of claim 19, further comprising an adjustable set screw which engages an outer portion of the grommet to adjust resistance to rotation of the clutch and drive shaft.

21. The apparatus of claim 16, wherein the gauge has a color scale having different color portions representing different ball compression factor ranges.

22. The apparatus of claim 21, wherein the gauge has a numeric scale representing a range of different ball compression factors.

23. The apparatus of claim 16, wherein the handle is of generally eyeglass-frame shape having first and second coplanar end portions each having an outer rim and an opening, and the central portion comprises a bridge between the outer rims which has a center region attached to the actuator which lies in a plane parallel to and offset from the plane of the end portions.

24. The apparatus of claim 16, wherein the handle has indicia indicating the direction of rotation of the handle to move the handle into the test position and the direction of rotation to return the handle from the test position to the release position.

25. A golf ball compression testing apparatus, comprising:
a main housing having opposite first and second ends, a longitudinal bore extending between the ends, and a ball testing chamber in the bore, the housing having an opening communicating with the ball testing chamber for placement of a ball in the chamber;
a first piston in the bore on one side of the chamber biased into an extended position engaging one side portion of a ball in the chamber;
a second piston in the bore on the opposite side of the chamber biased away from the chamber;
an actuator which engages the second piston to move the second piston into an extended position engaging an opposite side portion of a ball in the chamber;
a gauge at the second end of the housing associated with the first piston which measures deflection of the first piston when the second piston moves into the extended position with a ball in the chamber between the first and second pistons, the gauge having a color scale in which different color portions represent different ball compression factor ranges; and
a handle associated with the actuator and mounted on the housing for rotation between a release position extending transverse to the housing, and a test position aligned with the housing and extending over the opening, rotation of the handle into the test position moving the second piston into the extended position.
